(19) United States
(12) Patent Application Publication
(10) Pub. No.: US 2026/0030349 A1
(43) Pub. Date: Jan. 29, 2026

(54) ENRICHING AN EVENT STREAM WITH ENTITY STATE INFORMATION

(71) Applicant: CrowdStrike, Inc., Sunnyvale, CA (US)

(72) Inventors: Johnathan Hoyt, Reading, MA (US); Jason Cherry, North Andover, MA (US); Daniel Brown, Ipswich, MA (US)

(21) Appl. No.: 18/932,444

(22) Filed: Oct. 30, 2024

Related U.S. Application Data
(60) Provisional application No. 63/676,797, filed on Jul. 29, 2024.

(51) Int. Cl. G06F 21/55

(52) U.S. Cl. CPC G06F 21/554; G06F 16/2379; G06F 16/27; G06F 2221/034

(57) ABSTRACT

Techniques for enriching events with entity state data to provide distributing tracking of entity state data are provided. A cyber-security management (CSM) system may provide a set of configurations that each define entity identification information indicating when an entity(s) is referenced by an event being processed. When an event that is part of a stream of events is received, the set of configurations may be used by the CSM to identify an entity referenced by the event. The event may be routed to each node of a set of nodes of the CSM that is associated with the identified entity, where each of the nodes associated with the identified entity may update state information of the identified entity maintained by the node. Each of the nodes associated with the identified entity may also enrich the event with the state information of the entity.

### CROSS-REFERENCE TO RELATED APPLICATIONS

This application claims the benefit of U.S. provisional application No. 63/676,797, filed Jul. 29, 2024 and entitled “ENRICHING AN EVENT STREAM WITH ENTITY STATE INFORMATION,” the contents of which are hereby incorporated by reference.

### TECHNICAL FIELD

The present disclosure relates generally to cybersecurity, and more particularly, to systems and methods of for enriching events with entity state data to prevent the need for joins and lookups when downstream consumers of the events wish to access such information.

### BACKGROUND

Cybersecurity is the practice of protecting critical systems and sensitive information from digital attacks. Cybersecurity techniques are designed to combat threats against networked systems and applications, whether those threats originate from inside or outside of an organization.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for implementing a cyber-security platform, in accordance with some embodiments of the present disclosure.

FIG. 2 is a block diagram depicting the cyber-security platform of FIG. 1 implementing techniques for identifying entities within an arbitrary event stream, in accordance with some embodiments of the present disclosure.

FIG. 3 is a block diagram depicting the cyber-security platform of FIG. 1 implementing techniques for enriching an arbitrary events stream with entity state information, in accordance with some embodiments of the present disclosure.

FIG. 4 is a flow diagram depicting a method for enriching an arbitrary events stream with entity state information, in accordance with some embodiments of the present disclosure.

FIG. 5 is a block diagram of an example computing device that may perform one or more of the operations described herein, in accordance with some embodiments of the present disclosure.

### DETAILED DESCRIPTION

A cyber-security management (CSM) system may process events received from a variety of sources for threat detection and analysis purposes. Such events may reference entities, and there are many different entities that may be involved in a cyber-attack such as users, systems (aids), devices, and product detections, etc. It is useful to know information regarding the state of these entities (e.g., how long these entities have existed, when such entities ceased to exist) to make better judgements on whether certain events or behaviors are more or less likely to be malicious. Normally, such entity state information (hereinafter referred to as “state information”) is stored in external databases that must be queried in order to retrieve the state information.

However, the volume of some event streams may make it infeasible to query external databases to obtain state information for every entity referenced by every single event that comes through the CSM's event processing pipeline. In addition, many event streams are arbitrary event streams (i.e., may originate from a variety of sources and may have a variety of formats) for which the schemas that define the events therein are not fully known ahead of time. For example, the format of events within a third party event stream may not be known before the CSM receives/begins processing the third party event stream. As a result, it is infeasible to rely on hard coded logic to identify and track entities associated with events in an arbitrary event stream.

What is required is the ability to identify and correlate the entities referenced in an arbitrary event stream, track the entity state information for each entity referenced in the event stream, and enrich the event stream with state information for each of the entities referenced in the event stream so as to avoid expensive calls to external databases or systems when entity state information is required.

Aspects of the present disclosure address the above-noted and other deficiencies by providing in a CSM system, a set of configurations, where each configuration defines entity identification information that indicates when an entity(s) is referenced by an event being processed. The CSM system may comprise a set of nodes (logical or physical) that process events. When an event that is part of a stream of events is received, the set of configurations may be used to identify an entity referenced by the event. The event may be routed to each of the set of nodes that is associated with the identified entity, where each of the set of nodes associated with the entity may update state information of the identified entity maintained by the node. Each of the set of nodes associated with the identified entity may also enrich the event with the state information of the entity. By enriching events with state information as the events make their way through the CSM system's processing pipeline, joins and lookups are not required when downstream consumers of the events wish to access such information as it is readily available from the events themselves.

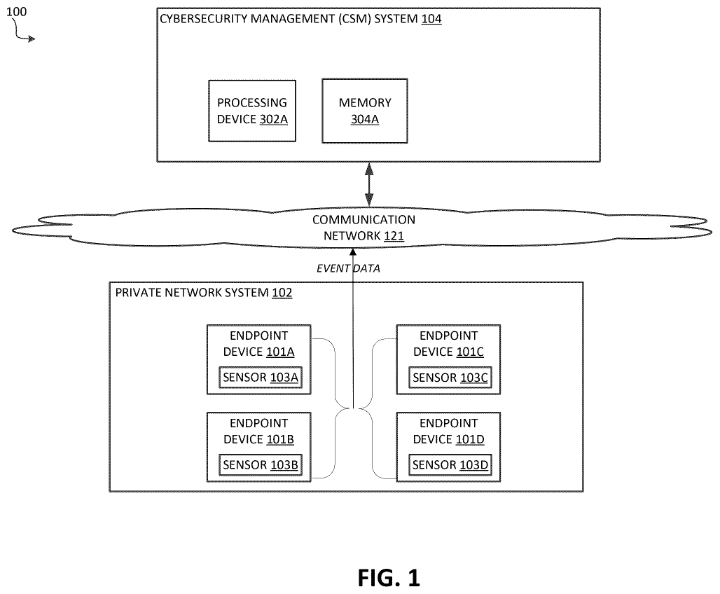

FIG. 1 is a block diagram depicting an example environment 100 for implementing a cyber-security management (CSM) system, according to some embodiments. The environment 100 includes and/or executes a CSM system 104, a private network system 102 (e.g., a corporate network, a local area network (LAN), a wide area network (WAN), a personal area network (PAN)). The private network system 102 includes endpoint devices 101 (e.g., endpoint device 101a, 101b, 101c, 101d) that are communicably coupled together via a private communication network of the private network system 102. The private network system 102 and the CSM system 104 are communicably coupled via a communication network 121.

The CSM system 104 includes a processing device 302A (e.g., general purpose processor, a PLD, etc.), which may be composed of one or more processors, and a memory 304A (e.g., synchronous dynamic random-access memory (DRAM), read-only memory (ROM)), which may communicate with each other via a bus (not shown).

The processing device 302A may be provided by one or more general-purpose processing devices such as a microprocessor, central processing unit, a graphic processing unit (GPU), or the like. In some embodiments, processing device 302A may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302A may include one or more special-purpose processing devices such as an application specific integrated circuit (ASIC), a field programmable gate array (FPGA), a digital signal processor (DSP), network processor, or the like. The processing device 302A may be configured to execute the operations described herein, in accordance with one or more aspects of the present disclosure, for performing the operations and steps discussed herein.

The memory 304A (e.g., Random Access Memory (RAM), Read-Only Memory (ROM), Non-volatile RAM (NVRAM), Flash Memory, hard disk storage, optical media, etc.) stores data and/or computer instructions/code for facilitating at least some of the various processes described herein. The memory 304A includes tangible, non-transient volatile memory, or non-volatile memory. The memory 304A stores programming logic (e.g., instructions/code) that, when executed by the processing device 302A, controls the operations of the CSM system 104. In some embodiments, the processing device 302A and the memory 304A form various processing devices and/or circuits described with respect to the CSM system 104. The instructions include code from any suitable computer programming language such as, but not limited to, C, C++, C#, Java, JavaScript, VBScript, Perl, HTML, XML, Python, TCL, and Basic.

While various devices, interfaces, and logic with particular functionality are shown, it should be understood that the CSM system 104 includes any number of devices and/or components, interfaces, and logic for facilitating the functions described herein. For example, the activities of multiple devices may be combined as a single device and implemented on the same processing device (e.g., processing device 302A), as additional devices and/or components with additional functionality are included.

In some embodiments, the CSM 104 deploys a sensor onto each of the endpoint devices 101 of the private network system 102 by sending (e.g., broadcasting) messages to the endpoint devices 101. The messages cause the endpoint devices 101 to install the sensor onto its own resources (e.g., memory, storage, processor). For example, endpoint device 101a installs sensor 103a, endpoint device 101b installs sensor 103b, endpoint device 101c installs sensor 103c, and endpoint device 101d installs sensor 103d (each collectively referred to as, sensors 103).

In some embodiments, the CSM 104 does not need to deploy a sensor onto each of the endpoint devices 101, but instead can leverage an already existing and deployed sensor 103 which is also configured to send the necessary telemetry data for the CSM 104 to function.

Each sensor 103 is configured to monitor (e.g., track) and detect each event involving the endpoint device 101 that executes the sensor 103. An event may include, for example, a process control call, a file management call, a device management call, an information management call, a communication call, a protection call, and/or the like. An event may also include any communication (e.g., transmission/transmit, reception/receive) that takes place between the endpoint device 101 and any other computing device (e.g., different endpoint device 101). Each communication includes a header (e.g., source network address, destination network address, and/or the like) and a message body (e.g., text, code, etc.). Each sensor 103 also assigns a time stamp to each detected event (including communications between the endpoint device 101 and any other computing device) and records each detected event in a local storage (e.g., memory, database, cache) of the respective endpoint device 101. Therefore, each endpoint device 101 may use its sensor 103 to keep track of all network addresses (e.g., internet protocol (IP) address, Media Access Control (MAC) address, telephone number, and/or the like) of the endpoint device 101 on the private network system 102 that are currently communication with the endpoint device 101 and/or have previously communicated (sometimes referred to as historical communication) with the endpoint device 101. The events stored by each endpoint device 101 may be referred to as event data. Each of the endpoint devices 101 of the private network system 102 periodically sends its locally stored event data to the CSM system 104 (i.e., the CSM system 104 may receive an event stream from each of the endpoint devices 101). The CSM 104 interprets the event data that is received using schemas that detail the format and structure of the events in the event data.

However, event streams may be arbitrary (i.e., may originate from any of a variety of sources and may have any of a variety of formats), and the CSM 104 may not have access to a schema to aid in parsing/understanding the events in an arbitrary event stream. In addition, as discussed hereinabove, there are many different entities that may be involved in a cyber-attack such as users, systems (aids), devices, product detections, etc. When processing an arbitrary event stream where the schema may not be fully known (or known at all) ahead of time, the CSM 104 cannot rely on hard coded logic to identify and track such entities from the events in the event stream. In order to identify and track such entities from arbitrary event streams, what is required is the ability to identify and correlate the entities referenced in an arbitrary event stream, track the state information for each entity referenced in an event stream, and enrich the event stream with state information for each of the entities referenced in the event stream so that such state information is available without the need for expensive calls to external databases or systems.

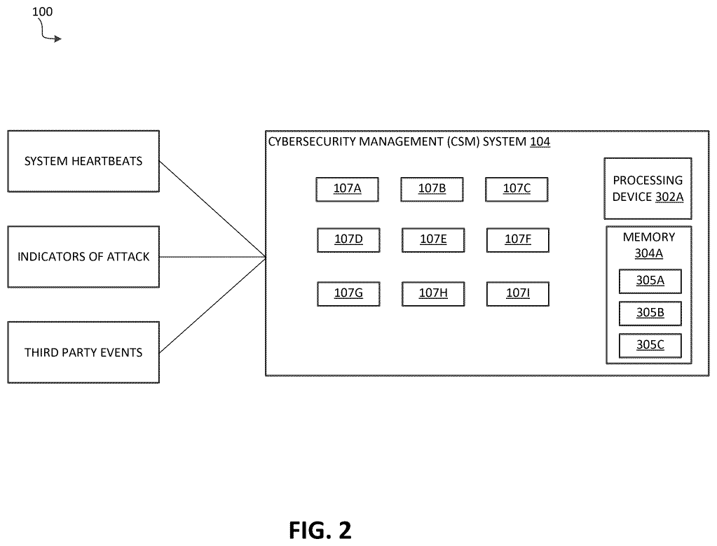

FIG. 2 illustrates the CSM 104 implementing techniques for identifying entities within an arbitrary event stream, in accordance with some embodiments of the present disclosure. The CSM 104 may comprise a plurality of nodes 107A-1071 for processing events. Each node 107 may comprise a logical unit (e.g., an abstraction of computing and memory resources of the processing device 302A and memory 304A respectively). In some embodiments, each node 107 may comprise its own physical computing device with hardware similar to the CSM 104 (e.g., processing device 302A and memory 304A). Each node 107 may be associated with one or more entities and may include logic for maintaining the state information of the associated entities as well as updating events that reference the associated entities with state information of the associated entities as discussed in further detail herein.

As discussed herein, the CSM 104 may receive events from a variety of sources. Examples of received events may include system heartbeats, indicators of attack and events included within third party data such as customer data and logs etc. The memory 304A may store a set of configurations 305A-305C which may assist the CSM 104 in identifying entities involved with events the CSM 104 is processing. Certain configurations 305 may be default configurations provided by the CSM 104 and which are predefined by e.g., a provider of the CSM 104. In addition, one or more of the configurations 305 may be defined and provided by a user e.g., an administrator/user of the private network system 102. Each configuration 305 may comprise any appropriate file type such as a Java script object notation (JSON) file. Each configuration 305 may define entity identification information (e.g., keys/fields and corresponding values thereof) that indicates when a particular entity is referenced by an event being processed, how to extract and/or normalize entity identification information and what entity states a node 107 should maintain for the particular entity (or entities). Each configuration 305 may define entity identification information for one or more entities. Examples of entity states may include:

“new”—indicating that the CSM 104 has not encountered this entity before/is encountering this entity for the first time
“active”—indicating that the entity is active (e.g., has been referenced in an event recently/within a threshold amount of time)
“silent”—indicating that the entity is not active (e.g., has not been referenced in an event recently/within the threshold amount of time)
“dead”—indicating that state information regarding the entity can be removed (e.g., because the entity has not been referenced in within a second “dead entity” threshold amount of time)

Each configuration 305 may also specify for the particular entity (or entities) it defines entity identification information for, how to track the state for that entity. More specifically, each configuration 305 may include rules to determine the current state (e.g., “new,” “active,” “silent”) of the entity (or entities) it defines entity identification information for. For example, a first rule of a set of rules may specify that an entity is in the “active” state if no more than a threshold amount of time has elapsed since the entity was last active. A second rule of the set of rules may specify that the entity is in the “silent” state if more than the threshold amount of time has elapsed since the entity was last active. A third rule of the set of rules may specify that the entity is in the “dead” state if more than a second threshold amount of time has elapsed since the entity was last active. An entity may be active when it is referenced by an event. The third rule may further specify that if the entity is in the “dead” state, the CSM 104 may assume that the entity has been removed and perform one or more actions such as clearing state associated with the entity and triggering messages to external systems instructing them to clear their state associated with the entity. Although illustrated with only three configurations 305A-305C, this is not a limitation and the memory 304A may include any appropriate number of configurations that each define entity identification information for any appropriate number of entities. In some embodiments, the CSM 104 may include a single configuration for each particular entity (i.e., each configuration 305 may define entity identification information for a single entity). It is important for each entity to have its own specifically defined entity identification information because different entities will have different lifespans, available states, etc.

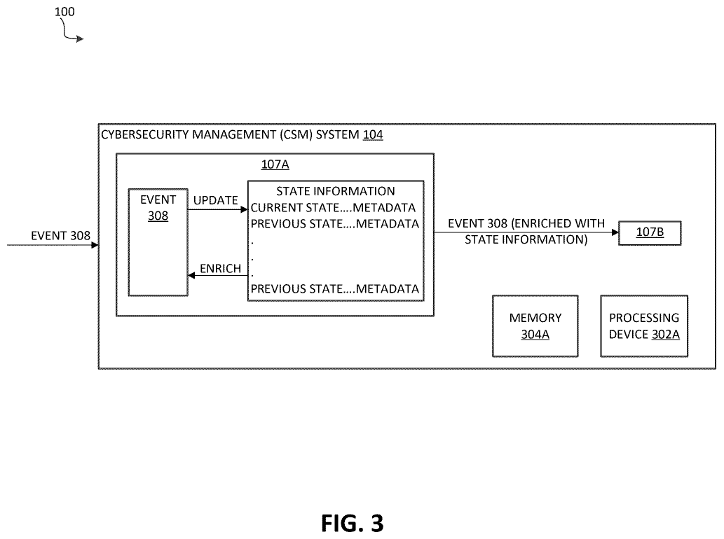

FIG. 3 illustrates the CSM 104 implementing techniques for enriching an arbitrary events stream with entity state data, in accordance with some embodiments of the present disclosure. The CSM 104 may receive an event 308 as part of an event stream and may analyze the event 308 using the configuration rules 305 and identify an entity (not shown) referenced by the event 308. In some embodiments, processing of event data originating from a particular type of entity may be performed by a particular set of nodes 107. For example, processing of event data originating from users may be handled by a first set of nodes 107 while processing of event data originating from a device may be handled by a second set of nodes 107. In other embodiments, event data originating from different entities of the same type may be processed by different sets of nodes 107 depending on e.g., “UserName” and “UserID” fields (and corresponding values) in the configuration 305. Thus, the CSM 104 may determine a set of nodes 107 associated with the identified entity and route the event 308 to each node 107 associated with the identified entity. The CSM 104 may determine the set of nodes 107 associated with the identified entity in a deterministic manner. For example, the CSM 104 may maintain a mapping of key (or field) values (as found in entity identification information of a configuration 305) to nodes 107 and identify the set of nodes 107 associated with the identified entity based on the key value used to identify the identified entity. In some embodiments, the CSM 104 may maintain a mapping of hashes of key values to nodes 107. In the example of FIG. 3, nodes 107A and 107B are the nodes 107 associated with the identified entity and the CSM 104 may first route the event 308 to the node 107A. When the event 308 reaches the node 107A, the node 107A may update the state information it has maintained for the identified entity with a new current state based on the event 308. The state information maintained by the node 107A for the identified entity may refer to the current state of the identified entity, all previous states of the identified entity, metadata associated with the current state, and metadata associated with each previous state such as time stamps and event types among others. The metadata associated with a current (or previous) state may also include information such as “UserName” and “UserID” fields (and corresponding values).

For example, the event 308 may include a heartbeat from the identified entity with a corresponding time stamp. Thus, the node 107A may set the current state of the identified entity as “active” and save as metadata associated with the current state, the corresponding time stamp to indicate when the identified entity was last active. The node 107A may also save as metadata associated with the current state, the event type (in this example, a heartbeat) as an indication of what the last activity of the identified entity was. The node 107A may use this time stamp in conjunction with the configurations 305 when determining if/when the current state of the identified entity should be changed to “silent” and/or “dead.”

In addition, the node 107A may enrich the event 308 with the (now updated) state information of the identified entity it has maintained. As a result, the event 308 may now include the current state as well as all previous states of the identified entity, as well as metadata associated with the current state and each previous state of the identified entity.

In some embodiments, in addition or as an alternative to enriching the event 308 with state information, the node 107A may also enrich the event 308 with a field seen in a separate event that also references the identified entity. For example, a separate event (not shown) that references the identified entity may be received by the node 107A. The separate event may include a field for “UserName” and another field for “UserID” and corresponding values for each field. When the node 107A updates the state information it has maintained for the identified entity based on the separate event, it may store both fields and their corresponding values as part of the metadata associated with the current state. Subsequently, the event 308 may be received by the node 107A, and the event 308 may only include the field for “UserID.” During the enrichment process, the node 107A may enrich the event 308 with the “UserName” field (and corresponding value) observed from the separate event.

The event 308 may then be routed to the node 107B, which may perform the same process of updating the state information it has maintained for the identified entity based on the event 308 and enriching the event 308 with the state information of the identified entity it has maintained. Although described with respect to event 308 referencing a single entity, this is for ease of illustration/description only and the event 308 may reference any appropriate number of entities and as a result be routed to different subsets of nodes 107 (as each entity referenced by the event 308 will have its own set of associated nodes 107). Thus, as the event 308 travels through the processing pipeline of the CSM 104, it may be used to update the state information maintained by relevant nodes 107 for any entities it references as well as be enriched with the state information of any entities it references. As a result, complete historical state information about each entity referenced by the event 308 can be included with the event 308 itself, and downstream consumers of the event 308 may have access to the complete historical state information for each referenced entity upon receipt of the event 308, thereby avoiding the need for joins or lookups from an event database or other external source.

Embodiments of the present disclosure remove the need for a central database or cache where state information is tracked and stored. Instead, state information is tracked in a distributed manner so that events can be routed to the nodes 107 that track the state for any entities that are referenced by those events. By enriching events with state information as the events make their way through the CSM 104's processing pipeline, joins and lookups are not required when downstream consumers of the events wish to access the state information of entities referenced by the events.

In addition, embodiments of the present disclosure also detect when entities cease to exist (and various other states) and allow for security platforms to use such information as indicators that a system has been tampered with, or for other use cases. Indeed, cessation of event data from an entity is one of the simplest and broadest ways to detecting tampering. As used herein, “tampering” means interfering with the prevention or communication abilities of an endpoint (e.g., interfering with the prevention or communication abilities of an endpoint detection and response (EDR) agent). Although reliance on cessation of event data alone can result in a number of benign/false positive cases due to intended sensor uninstallation, reboots, shutdowns, and suspension (e.g., laptop lid closing), this can be overcome by correlating cessation of event data with other attack indicators. For example, tampering is often preceded by malicious or suspicious activity. Thus, embodiments of the present disclosure contemplate looking for cessation of event data that occurs within a certain amount of time of identified suspicious activity. Such methods can be enhanced by observing the recent behavior of activity (e.g., sensor heartbeats) on a given host. If cessation of the heartbeat is rare, this provides more confidence in the link between the time proximity of suspicious activity and the cessation of event data. Similarly, the actual time proximity of the cessation and the suspicious activity would also be a factor accounted for by the CSM 104.

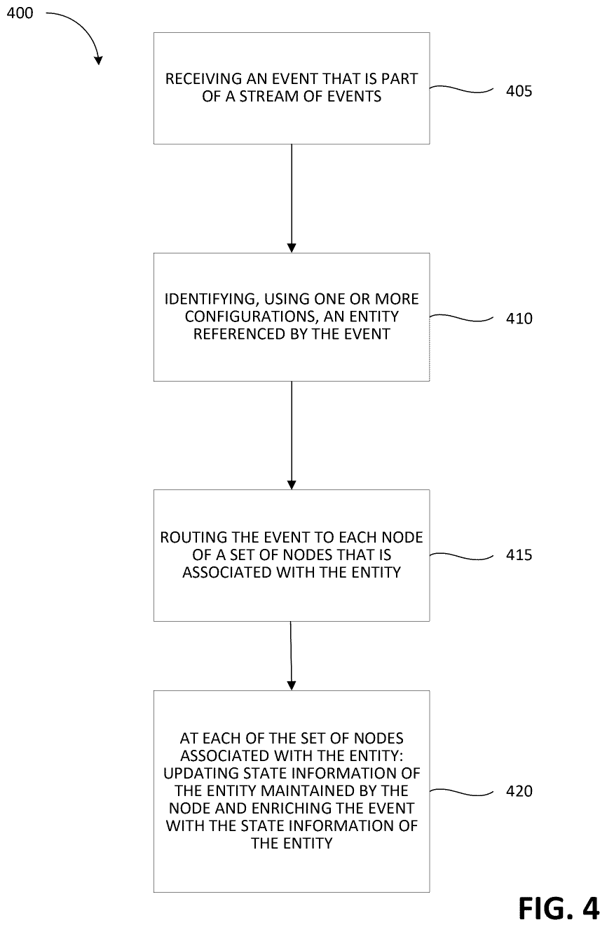

FIG. 4 is a flow diagram depicting a method for enriching an arbitrary events stream with entity state information, in accordance with some embodiments of the present disclosure. Method 400 may be performed by processing logic that may include hardware (e.g., circuitry, dedicated logic, programmable logic, a processor, a processing device, a central processing unit (CPU), a graphic processing unit (GPU), a system-on-chip (SoC), etc.), software (e.g., instructions running/executing on a processing device), firmware (e.g., microcode), or a combination thereof. In some embodiments, method 400 may be performed by a cybersecurity management (CSM) system, such as the CSM system 104 in FIGS. 1-3.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring also to FIG. 3, at block 405 the CSM 104 may receive an event 308 as part of an event stream and may analyze the event 308 using the configuration rules 305 at block 410 to identify an entity (not shown) referenced by the event 308. The CSM 104 may determine a set of nodes 107 associated with the identified entity and at block 415 may route the event 308 to each node 107 associated with the identified entity. In the example of FIG. 3, nodes 107a and 107b are the nodes 107 associated with the identified entity and the CSM 104 may first route the event 308 to the node 107A. At block 420, when the event 308 reaches the node 107A, the node 107A may update the state information it has maintained for the identified entity with a new current state based on the event 308. The state information maintained for the identified entity may refer to the current state of the identified entity, all previous states of the identified entity, as well as metadata associated with the current state and metadata associated with each each previous state such as time stamps and event types among others. The metadata associated with a current (or previous) state may also include information such as “UserName” and “UserID” fields (and corresponding values).

For example, the event 308 may include a heartbeat from the identified entity with a corresponding time stamp. Thus, the node 107A may set the current state of the identified entity as “active” and save as metadata associated with the current state, the time stamp indicating when the identified entity was last active as well as the heartbeat as an indication of what the last activity of the identified entity was. The node 107A may use this time stamp in conjunction with the configurations 305 when determining if/when the current state of the identified entity should be changed to “silent” and/or “dead.”

In addition, the node 107A may enrich the event 308 with the (now updated) state information of the identified entity it has maintained. As a result, the event 308 may now include the current state as well as all previous states of the identified entity, as well as metadata associated with the current state and metadata associated with each previous state of the identified entity.

In some embodiments, in addition or as an alternative to enriching the event 308 with state information, the node 107A may also enrich the event 308 with any field seen in a separate event that also references the identified entity. For example, a separate event (not shown) that references the identified entity may be received by the node 107A. The separate event may include a field for “UserName” and another field for “UserID” and corresponding values for each field. When the node 107A updates its state information for the identified entity based on the separate event, it may store both fields and their corresponding values as part of the metadata associated with the current state. Subsequently, the event 308 may be received by the node 107A, and the event 308 may only include the field for “UserID.” During the enrichment process, the node 107A may enrich the event 308 with the “UserName” field (and corresponding value) observed from the separate event.

The event 308 may then be routed to the node 107B, which may perform the same process of updating the state information it has maintained for the identified entity based on the event 308 and enriching the event 308 with the state information of the identified entity it has maintained. Although described with respect to event 308 referencing a single entity, this is for ease of illustration/description only and the event 308 may reference any appropriate number of entities and as a result be routed to different subsets of nodes 107 (as each entity referenced by the event 308 will have its own set of associated nodes 107). Thus, as the event 308 travels through the processing pipeline of the CSM 104, it may be used to update the state information maintained by relevant nodes 107 for any entities it references as well as be enriched with the state information of any entities it references. As a result, complete historical state information about each entity referenced by the event 308 can be included with the event 308 itself, and downstream consumers of the event 308 may have access to the complete historical state information for each referenced entity upon receipt of the event 308, thereby avoiding the need for joins or lookups from an event database or other external source to obtain the complete historical state information.

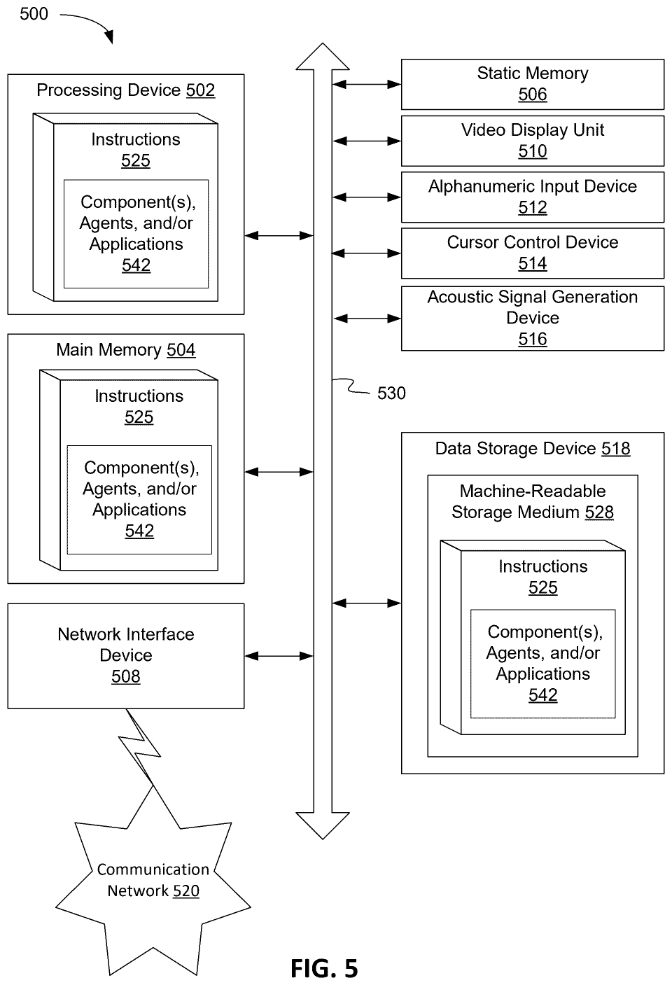

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general-purpose processor, a PLD, etc.) 502, a main memory 504 (e.g., synchronous dynamic random-access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a communication network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 525 that may include instructions for one or more components/programs/applications/platforms 542 for carrying out the operations described herein, in accordance with one or more aspects of the present disclosure. Instructions 525 may also reside, completely or at least partially, within main memory 504 and/or within processing device 502 during execution thereof by computing device 500, main memory 504 and processing device 502 also constituting computer-readable media. The instructions 525 may further be transmitted or received over a communication network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “identifying,” “routing,” “updating,” “enriching,” “determining,” “storing,” “generating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112 (f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

1. A method comprising:
receiving an event that is part of a stream of events;
identifying an entity referenced by the event;
determining a node associated with the entity;
routing the event to the node associated with the entity; and
at the node associated with the entity:
updating, by a processing device, state information of the entity maintained by the node based on the event, wherein the state information of the entity maintained by the node comprises a current state of the entity, each previous state of the entity, metadata associated with the current state of the entity, and metadata associated with each of the previous states of the entity; and
updating the event with the updated state information of the entity maintained by the node.

2. The method of claim 1, wherein identifying the entity comprises:
using a configuration to identify the entity, wherein the configuration comprises entity identification information indicating when the entity is referenced by a particular event.

3. (canceled)

4. The method of claim 2, wherein updating the state information of the entity maintained by the node comprises:
updating the current state of the entity to indicate an active state;
saving as part of the metadata associated with the current state of the entity, a time stamp associated with the event as an indication of a time when the entity was last active; and
saving as part of the metadata associated with the current state of the entity, an event type of the event as an indication of a last activity of the entity.

5. The method of claim 4, wherein the entity identification information comprises a key and a corresponding value for the key, and wherein the configuration further comprises:
a set of states each of the set of nodes is to maintain for the entity; and
rules to determine the current state of the entity.

6. The method of claim 5, further comprising:
determining, based on the configuration and the metadata associated with the current state of the entity, whether the current state of the entity should be changed.

7. The method of claim 5, further comprising:
maintaining a mapping of the corresponding value for the key to the node, and wherein the node is determined using the mapping.

8. A system comprising:
a memory; and
a processing device operatively coupled to the memory, the processing device to:
receive an event that is part of a stream of events;
identify an entity referenced by the event;
determine a set of nodes associated with the entity;
route the event to each of the set of nodes associated with the entity; and
at each of the set of nodes associated with the entity:
update state information of the entity maintained by the node based on the event, wherein the state information of the entity maintained by the node comprises a current state of the entity, each previous state of the entity, metadata associated with the current state of the entity, and metadata associated with each of the previous states of the entity; and
update the event with the updated state information of the entity maintained by the node.

9. The system of claim 8, wherein to identify the entity, the processing device is to:
use a configuration to identify the entity, wherein the configuration comprises entity identification information indicating when the entity is referenced by a particular event.

10. (canceled)

11. The system of claim 9, wherein to update the state information of the entity maintained by the node, the processing device is to:
update the current state of the entity to indicate an active state;
save as part of the metadata associated with the current state of the entity, a time stamp associated with the event as an indication of a time when the entity was last active; and
save as part of the metadata associated with the current state of the entity, an event type of the event as an indication of a last activity of the entity.

12. The system of claim 11, wherein the entity identification information comprises a key and a corresponding value for the key, and wherein the configuration further comprises:
a set of states each of the set of nodes is to maintain for the entity; and
rules to determine the current state of the entity.

13. The system of claim 12, wherein the processing device is further to:
determine, based on the configuration and the metadata associated with the current state of the entity, whether the current state of the entity should be changed.

14. The system of claim 12, wherein the processing device is further to:
maintain a mapping of the corresponding value for the key to the set of nodes, and wherein the processing device determines the set of nodes using the mapping.

15. A non-transitory computer-readable medium having instructions stored thereon which, when executed by a processing device, cause the processing device to:
receive an event that is part of a stream of events;
identify an entity referenced by the event;
determine a set of nodes associated with the entity;
route the event to each of the set of nodes associated with the entity; and
at each of the set of nodes associated with the entity:
update, by the processing device, state information of the entity maintained by the node based on the event, wherein the state information of the entity maintained by the node comprises a current state of the entity, each previous state of the entity, metadata associated with the current state of the entity, and metadata associated with each of the previous states of the entity; and
update the event with the updated state information of the entity maintained by the node.

16. The non-transitory computer-readable medium of claim 15, wherein to identify the entity, the processing device is to:
use a configuration to identify the entity, wherein the configuration comprises entity identification information indicating when the entity is referenced by a particular event.

17. (canceled)

18. The non-transitory computer-readable medium of claim 16, wherein to update the state information of the entity maintained by the node, the processing device is to:
update the current state of the entity to indicate an active state;
save as part of the metadata associated with the current state of the entity, a time stamp associated with the event as an indication of a time when the entity was last active; and
save as part of the metadata associated with the current state of the entity, an event type of the event as an indication of a last activity of the entity.

19. The non-transitory computer-readable medium of claim 18, wherein the entity identification information comprises a key and a corresponding value for the key, and wherein the configuration further comprises:
a set of states each of the set of nodes is to maintain for the entity; and
rules to determine the current state of the entity.

20. The non-transitory computer-readable medium of claim 19, wherein the processing device is further to:
determine, based on the configuration and the metadata associated with the current state of the entity, whether the current state of the entity should be changed.
